(19) United States
(12) Patent Application Publication
(10) Pub. No.: US 2014/0023070 A1
(43) Pub. Date: Jan. 23, 2014

(54) METHOD AND APPARATUS FOR EXCHANGING MESSAGES

(71) Applicant: SENSINODE OY, Oulu (FI)

(72) Inventor: Petri Tapani MUTKA, Oulu (FI)

(21) Appl. No.: 13/942,781

(22) Filed: Jul. 16, 2013

(30) Foreign Application Priority Data
Jul. 18, 2012 (FI) 20125809

(51) Int. Cl. H04L 12/701

(52) U.S. Cl. CPC H04L 45/00
USPC 370/389

(57) ABSTRACT

A method and apparatus for exchanging messages between entities in a packet network. The solution includes exchanging a predetermined number of data entities with an apparatus by transmitting and receiving frames having one or more data fields; each frame including a field indicating which data entities the transmitting apparatus has not yet received successfully, and when a data entity is split into more than one data field, transmitting and receiving each data field having a part of the data entity with a sub field indicating which data fields include a part of the data entity the transmitting apparatus has not yet received successfully.

### PRIORITY CLAIM

This patent application claims priority to Finnish Patent Application No. 20125809, filed 18 Jul. 2012, the disclosure of which is incorporated herein by reference in its entirety.

### FIELD

Disclosed embodiments relate to a method and an apparatus in a packet network. In particular, disclosed embodiments relate to exchanging messages between entities in a packet network.

### BACKGROUND

The following description of background art may include insights, discoveries, understandings or disclosures, or associations together with disclosures not known to the relevant art prior to the present disclosed embodiments but provided by the disclosed embodiments. Some of such contributions may be specifically pointed out below, whereas other such contributions will be apparent from their context.

In modern communication and computer networks, data exchange between programs and computers is a vital element. Information must be exchanged reliably. For this reason, in many applications the recipients of messages are required to acknowledge the successful reception of the messages. This applies especially to networks utilizing packet based transmission.

Many solutions for ensuring reliable transmission have been developed. However, these solutions do not take into account the existence of constrained networks, i.e. networks having limited resources, power and bandwidth available for communication. An example of a constrained network is a machine-to-machine (M2M) network realized using low-power wireless connections.

Especially in large M2M networks with large numbers of devices with small processing power and minimum power consumption it is important to utilize efficient solutions for communication.

### SUMMARY

Disclosed embodiments provide an improved solution for exchanging messages between entities in a packet network.

At least one disclosed embodiment provides an apparatus, in a packet network, comprising at least one processor; and at least one memory including computer program code, the at least one memory and the computer program code configured to, with the at least one processor, cause the apparatus at least to perform: exchange a predetermined number of data entities between another apparatus by transmitting and receiving frames comprising one or more data fields; each frame comprising a field indicating which data entities the transmitting apparatus has not yet received successfully, and when a data entity is split into more than one data field, transmit and receive each data field comprising a part of the data entity with a sub field indicating which data fields comprising a part of the data entity the transmitting apparatus has not yet received successfully.

Another disclosed embodiment provides a method, in a web service system, comprising exchanging a predetermined number of data entities with an apparatus by transmitting and receiving frames comprising one or more data fields; each frame comprising a field indicating which data entities the transmitting apparatus has not yet received successfully, and when a data entity is split into more than one data field, transmitting and receiving each data field comprising a part of the data entity with a sub field indicating which data fields comprising a part of the data entity the transmitting apparatus has not yet received successfully.

### BRIEF DESCRIPTION OF THE DRAWINGS

Disclosed embodiments are described below, by way of example only, with reference to the accompanying drawings, in which

FIG. 1 illustrates an example of an authentication procedure where two devices perform authentication;

FIG. 2 illustrates an example where two devices exchange data;

FIG. 3 illustrates an example a field in a certificate message; and

FIG. 4 illustrates an example of a device in which some disclosed embodiments may be applied.

### DETAILED DESCRIPTION OF THE DISCLOSED EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Data exchange between programs and computers is a vital element. Different programs, computers and processors may exchange data without human intervention. Different networks and protocols are used in different environments. On the Internet, the Transmission Control Protocol/Internet Protocol (TCP/IP) is the basic protocol used in communication. TCP/IP takes care of assembling and disassembling the data to be transmitted in packets. IP handles the addressing so that packets are delivered to the correct destination. Above TCP/IP, the Hypertext Transfer Protocol (HTTP) is used as a client/server protocol. A program may send an HTTP request to a server which responds with another HTTP message.

Low-power wireless networks, such as IEEE 802.15.4 based embedded and sensor networks, have extremely limited resources for transmitting packets. These networks are very energy-efficient, and the chip technology is cheap. For this reason the technology is making its way to embedded devices very quickly for automation, measurement, tracking and control, for example.

In low-power wireless networks, current web service technologies are far too complex (headers, content parsing) and heavy (large header and content overhead). Recently, binary web service protocols have been developed for low-power wireless networks. A binary web service solution includes the use of a suitable web service protocol (such as simplified HTTP or a binary web service protocol such as Constrained Application Protocol CoAP) and an efficient content encoding (such as Efficient XML Interchange EXI, Binary XML or Fast Infoset FI).

In some, if not most, communication between computers the sender of a message requires an acknowledgement from the recipient so that the sender may be sure that the message has been received. Examples of this kind of communication are authenticated and/or encrypted connections.

In computer networks, authenticated and encrypted connections require a handshake when a connection between two peers is established. A cryptographic handshake requires reliable exchange of cryptographic parameters and data. In the TCP network environment, this is done with an encryption protocol called the Transport Layer Security TLS, where the transmission layer guarantees ordering and delivery of transmitted packets, and takes care of fragmentation. In radio packet networks and other constrained environments, implementation of the TCP is problematic.

For this reason the use of User Datagram Protocol UDP based solutions have been proposed. An example of a UDP based solution is Datagram Transport Layer Security DTLS, which is an encryption protocol that is used for authorization, authentication and securing of data traffic on the UDP. However, DTLS solves the handshake message delivery by implementing a TCP-like traffic control at the authentication layer. This approach is cumbersome and neglects the advantages of the UDP protocol.

In at least one disclosed embodiment, an improved solution for exchanging messages between entities is proposed. The proposed method for handshake data exchange does not need any external traffic control (provided by TCP/IP, for example). It is configured to work in networks where there is no guarantee of reliable message delivery, nor resend or congestion control mechanisms. Furthermore, the message ordering may be arbitrary.

In the proposed solution, two entities are exchanging a predetermined number of data fields. In another disclosed embodiment, the entities are configured to exchange the same data fields. The exchange may be realized by transmitting frames or messages between the entities, the frames or messages comprising one or more data fields each. The entities are configured to include in each frame or message a field indicating which data fields the transmitting entity has not yet received successfully. The field may be denoted as an ACK field. In a further disclosed embodiment, the ACK field is a bit field comprising an acknowledgment bit for each handshake data fields to be exchanged.

In yet another disclosed embodiment, each sent frame is included with an ACK field, where the sender is communicating which handshake data fields it has not yet received. The receiver of the frame must (re)send all the indicated data fields, and send its own corresponding ACK field with the reply frame. The data exchange is continued until the both peers have sent and received frames with ACK fields indicating that all required data fields have been successfully received.

In some cases, the data to be exchanged between devices comprises data entities that are too large to fit in a single data field. In other words, that may be larger than the maximum transfer unit (MTU) of a network. MTU can be defined as the largest packet than can be transmitted over a network without fragmentation.

An example of a large data entity is a chain of certificates used in authentication procedures. During a cryptographic handshake the peers use certificates for authenticating themselves. Sometimes this requires sending a chain of certificates in order to establish a chain of trust from a peer to the root certificate agency. The chain of certificates is an ordered queue of individual certificates, where each certificate can be verified with its predecessor in the queue. The private key of the top level certificate is owned by the peer, and the root level certificate is issued by a trusted certificate vendor. With this chain, the trust relationship is extended from the trusted root certificate issuer company to the peer owning the top level certificate. A chain of certificates is often larger than the MTU of the network layer.

In still another disclosed embodiment, the certificate chains, as well as any other data entities larger than the MTU of a network, can be fragmented by nesting ACK field schemes. During an ACK field exchange, a single data field/message type must be successfully exchanged only once. After the successful message delivery the ACK field bit is set. However, when a message type contains more data than the MTU of the carrier protocol of the network can handle, the message must be fragmented. It is proposed to handle the fragmentation by nesting the ACK field schemes in such a way that the large data entity is sent part by part with its own ACK field exchange, that is piggy-backing on top of the ongoing top-level ACK filed scheme. The top level ACK bit is set only after multiple exchanges of the top level messages that complete the nested ACK field scheme for the fragmented data entity.

For example, during an ACK field message exchange in a security handshake, the message type carrying a certificate is allowed to be sent and received multiple times. Each certificate message may contain a single certificate, information about its position in the certificate chain and an ACK field. The certificate messages are sent with their own ACK field scheme mechanism using ACK fields for each certificate in the chain. All the certificate messages are exchanged according to the ACK field scheme, and the top level ACK is set only after the certificate message ACK field scheme has been completed.

The received certificates are cached and verified immediately when it becomes possible by receiving adjacent certificate from the queue. Only the unverified certificates and state of the completed parts of the trust chain is stored by the peer.

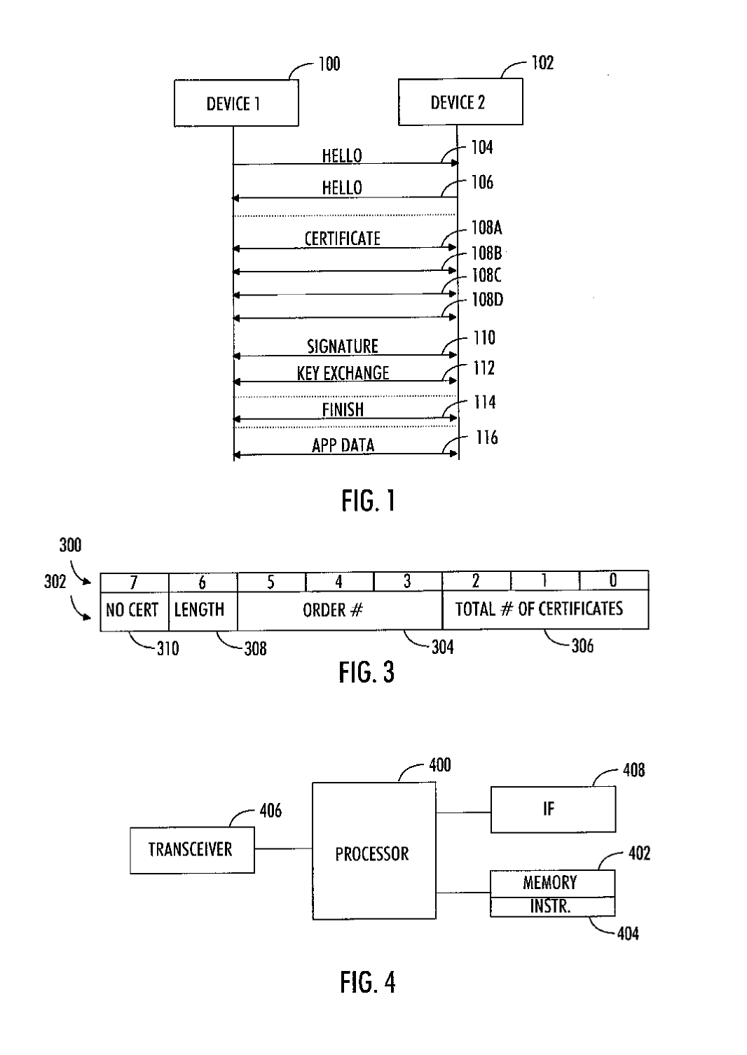

FIG. 1 illustrates an example of an authentication procedure where two devices 100, 102, perform authentication by exchanging a given number of data fields, namely certificate, signature and key exchange data fields.

The process starts with exchanging hello data fields 104, 106 between the devices which initiate the exchange. Next, the devices exchange frames comprising certificate, signature and key exchange data fields. Each frame with one or more of the above mentioned data fields comprises in addition an ACK field which indicates the data fields the sender of the frame has received. The exchange of these data fields continues until both devices are able to send an ACK field 114 indicating that all data fields have been received. When that happens, the authentication has been completed and the devices may begin exchanging application data 116. In this example, the certificate data entity comprises a chain of certificates that is too large to fit in a single transmission unit or data field. In this example, the transmission of the chain of certificates requires four data fields 108A to 108D. The signature and key exchange data entities fit into a single data field 110, 112, respectively.

Each data field comprising a part of the certificate data entity comprises an ACK sub field indicating which data fields comprising a part of the certificate data entity the transmitting apparatus has not yet received successfully. When the ACK sub field indicates all data fields comprising a part of the certificate data entity has been received the top level ACK may be set.

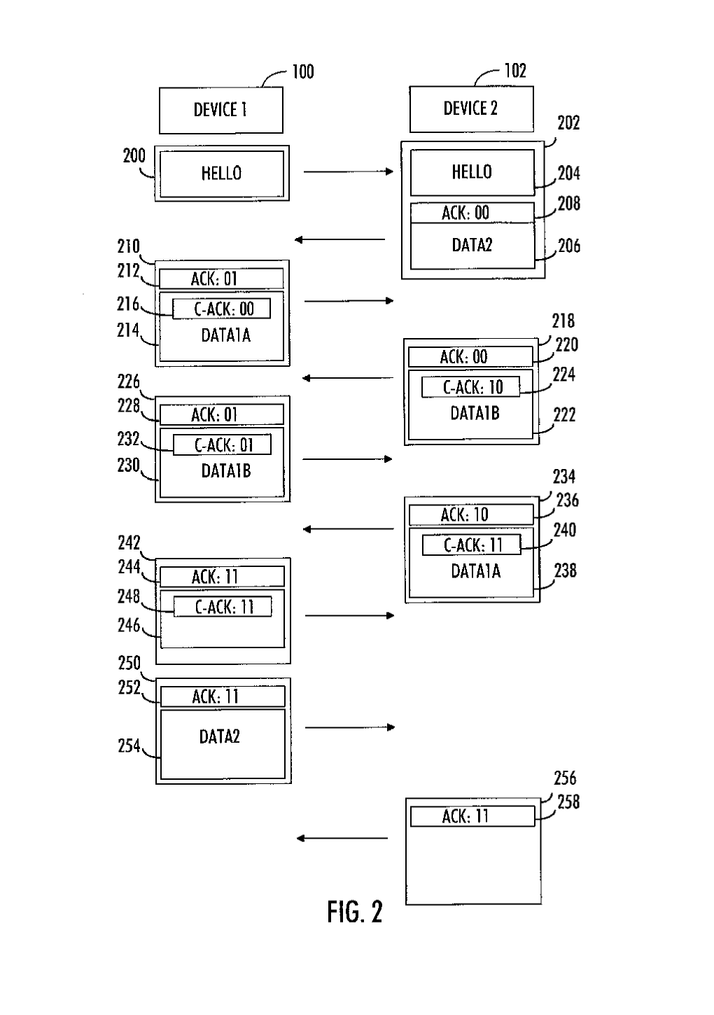

FIG. 2 illustrates another example where two devices 100, 102 are configured to exchange two data entities, data1 and data2. The order in which the data fields are exchanged is arbitrary. In this example, the transmission of the data1 entity requires two data fields (denoted as data1A and data1B) whereas data entity data 2 fits into one data field.

First, the first device 100 transmits a frame 200 comprising a hello data field. The second device 102 transmits a frame 202 comprising a hello data field 204 and data2 data field 206. The frame comprises an ACK field 208 with values 00 indicating that the second device has not received any of the two required data entities yet. In this example, bits of the ACK field are ordered as data1 and data2 from left to right.

The first device transmits a frame 210 comprising data field 214 comprising a part of the data entity data1 (denoted as data1A) and a sub ACK field 216 having a value 00 indicating that the device has not yet received any parts of the data entity data1. The frame 210 further comprises an ACK field 212 with values 01 indicating that it has received data entity data2.

The second device 102 transmits a frame 218 comprising data field 222 comprising a part of the data entity data1 (denoted as data1B) and a sub ACK field 224 having a value 10 indicating that the device has received first part (data1A) of the data entity data1. The frame 218 further comprises an ACK field 220 with values 00 indicating that it has not yet received any complete data entity.

Next in this example, the first device 100 transmits a frame 226 comprising data field 230 comprising a part of the data entity data1 (denoted as data1B) and a sub ACK field 232 having a value 01 indicating that the device has received second part (data1B) of the data entity data1. The frame 226 further comprises an ACK field 228 with values 01 indicating that it has received data entity data2.

Next, the second device 102 transmits a frame 234 comprising data field 238 comprising a part of the data entity data1 (denoted as data1A) and a sub ACK field 240 having a value 11 indicating that the device has received all parts of the data entity data1. The frame 234 further comprises an ACK field 236 with values 10 indicating that it has received complete data entity data1.

Next in this example, the first device 100 transmits a frame 242 comprising data field 246 a sub ACK field 248 having a value 11 indicating that the device has received all parts of the data entity data1. The frame 242 further comprises an ACK field 244 with values 11 indicating that it has received all required data entities.

Next in this example, the first device 100 transmits a frame 250 comprising data2 data field 254. The frame 250 further comprises an ACK field 252 with values 11 indicating that it has received all required data entities.

Finally in this example, the second device 102 transmits a frame 256 comprising an ACK field 258 with values 11 indicating that it has received all required data entities.

In another disclosed embodiment, data entities fragmented into more than one messages may be transmitted in any order and the receiving peer is able to combine the original data entities. This embodiment is illustrated above. To enable the combination the messages may comprise information which indicates the receiving peer the correct order of the messages comprising parts of the data entity.

An example of a large data entity which may be fragmented is a chain of certificates used in authentication. A single message may comprise a single certificate and the chain of certificates is obtained by combining the certificate messages. The receiving peer may be configured to receive and store each certificate message, combine and verify the chain when all certificate messages have been received.

In at least one disclosed embodiment, the certificate message is of following type:

CertificateType cert_type;
struct {
uint8 flags;
uint8 cert_ack;
uint16 length;
uint8 cert_data[length];
} Certificate;

In the above example, a message comprises a flags-field, a cert-ack field, and cert_{1'}data field which are 8-bit unsigned integers and length-data field which is 16-bit unsigned integer. However, these data fields and data types are merely an example illustrating at least one disclosed embodiment. In practice, the messages may utilize other data fields and other data types.

FIG. 3 illustrates the structure of the flags-field. The figure illustrates the bit number 300 and usage 302 of each bit. The flags-field in a certificate message comprises a subfield 304 to indicate ordering number for the included certificate in the certificate chain, a subfield 306 to indicate the total number of certificates within the complete certificate chain, and a subfield 308 to indicate the presence of an optional length field. The certificate count field 304 values are equal to the bit value of the field incremented by one, i.e. each field can have values ranging from one to eight. The top level certificate has smallest value and the certificate closest to the root certificate the greatest value. Note that it is not compulsory to actually send the root certificate in the communicated chain, since it is already known by the peer. If the peer is not prepared to send a certificate, only the flags field with the most significant bit 310 set is sent within the certificate message.

The cert_ack field is used for acknowledgment field for certificate chains consisting of more than one certificate. Each certificate in the chain has own acknowledgment slot, and unused slots are set to value one. When this field is completely filled, all the certificates in the chain have been received, and the acknowledgment flag at the handshake level can be set. This field is included into the message, if the length subfield 308 of flags-field indicates a value greater than one. The least significant bit indicates the top level certificate, while the most significant bit is closest to the root certificate.

The optional length field for the certificate data may be used, if the length of the certificate cannot be inferred from the frame size, or UDP packet size.

The cert_data-field is an octet stream containing certificate data. A certificate message may contain only a single certificate from the certificate chain. If the most significant bit 310 in the flags field is set, this field is empty.

FIG. 4 illustrates a further disclosed embodiment. The figure illustrates a simplified example of a device in which some disclosed embodiments may be applied. In some disclosed embodiments, the device may be a node of a machine-to-machine constrained packet network. In some disclosed embodiments, the device may be user equipment UE or a respective device communicating with a communications network. In some disclosed embodiments, the device may be a part of user equipment or a respective device. In general, device may a computing device, including wireless mobile communication device operating with or without a subscriber identification module (SIM).

In at least one disclosed embodiment, the device may have limited memory and processing capabilities, may sleep most of the time, and operate using a constrained network technology.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 400 configured to control at least part of the operation of the device.

The device may comprise a memory 402 for storing data. Furthermore the memory may store software instructions 404 executable by the control circuitry 400. The memory may be integrated in the control circuitry.

The device comprises a transceiver 406. The transceiver is operationally connected to the control circuitry 400. The transceiver is configured to communicate with a packet network which may be a machine-to-machine network, a constrained network or any other type of communication network.

The software 404 may comprise a computer program comprising program code means adapted to cause the control circuitry 400 of the device to control a transceiver 406.

The device may further comprise interface 408 operationally connected to the control circuitry 400. The device may be operationally connected to one or more external devices.

The control circuitry 400 is configured to execute one or more applications. The applications may be stored in the memory 402. The applications may configure the device to communicate with another device utilizing methods described above. The applications may require data from another device or they may store data another device.

In at least one disclosed embodiment, when exchanging data (data fields, messages and/or frames) with another device, the device may have a buffer for data fields to be transmitted. The buffer may be a reserved part of the memory 402 or it may be in another memory unit.

The device may comprise a memory for caching received data items such as certificates.

In another disclosed embodiment, the buffer may be an automatic send buffer, that (re)sends all the contents of the buffer a fixed number of times at predefined intervals, and quits after the final retry if there is no further communication from the other device. A device inserts all the frames to be sent into this buffer. Any communication from the other device flushes the stored messages from the send buffer.

The proposed solution is more lightweight than the usual traffic control solutions during the handshake that are based on sequencing and caching of the messages. The scheme is based on adaptation to the transport layer properties instead of forcing the transport layer to work in a sequential way. Therefore it is more lightweight and simpler than the usual implementations. Optimally, the number of sent messages is also less.

The proposed solution can be used in any context where two peers must exchange the data fields with peer related individual values. In still another disclosed embodiment, the number of data fields to be exchanges is the same in both directions. An example of such situation is a security handshake. An example is an authenticated asymmetric TLS-like exchange between a client and a server.

In at least one disclosed embodiment, the number of data fields to be exchanges is different in different directions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In a further disclosed embodiment, the device implementing aspects may be realized as software, or computer program or programs in a processing system.

In another disclosed embodiment, the apparatus implementing aspects may be realized as software in a node, a server, a computer or a set of computers of a web service system connected to Internet.

The computer programs may be in source code form, object code form, or in some intermediate form, and it may be stored in some sort of carrier, which may be any entity or device capable of carrying the program. Such carriers include a record medium, computer memory, read-only memory, and software distribution package, for example. Depending on the processing power needed, the computer program may be executed in a single electronic digital controller or it may be distributed amongst a number of controllers.

In yet another disclosed embodiment, the apparatus may be realized by means for exchanging a predetermined number of data entities with an apparatus by transmitting and receiving frames comprising one or more data fields; each frame comprising a field indicating which data entities the transmitting apparatus has not yet received successfully, and when a data entity is split into more than one data field, means for transmitting and receiving each data field comprising a part of the data entity with a sub field indicating which data fields comprising a part of the data entity the transmitting apparatus has not yet received successfully.

It will be obvious to a person skilled in the art that, as technology advances, the inventive concept can be implemented in various ways. The disclosed embodiments are not limited to the examples described above but may vary within the scope of the claims.

1. An apparatus in a packet network, comprising:
at least one processor; and
at least one memory including computer program code,
the at least one memory and the computer program code configured to, with the at least one processor, cause the apparatus at least to perform:
exchange a predetermined number of data entities between another apparatus by transmitting and receiving frames comprising one or more data fields; each frame comprising a field indicating which data entities the transmitting apparatus has not yet received successfully,
and when a data entity is split into more than one data field,
transmit and receive each data field comprising a part of the data entity with a sub field indicating which data fields comprising a part of the data entity the transmitting apparatus has not yet received successfully.

2. The apparatus of claim 1, wherein the apparatus is configured to transmit and receive data fields comprising a part of the data entity wherein the data fields comprise information on how to combine the parts of the data entity together.

3. The apparatus of claim 1, wherein the apparatus is configured to transmit and receive data fields comprising a part of the data entity wherein the data fields comprise information on the size of the part of the data entity in the data field.

4. The apparatus of claim 1, wherein the apparatus is configured to continue the transmission of data fields comprising a part of the data entity until receiving a data field with a subfield indicating that all data fields comprising a part of the data entity have been received successfully.

5. The apparatus of claim 1, wherein the apparatus is configured to transmit a data field comprising only a sub field indicating which data fields comprising a part of the data entity the transmitting apparatus has not yet received successfully if the receiving apparatus has indicated there are no data fields it has not received.

6. A method in a web service system, comprising:
exchanging a predetermined number of data entities with an apparatus by transmitting and receiving frames comprising one or more data fields; each frame comprising a field indicating which data entities the transmitting apparatus has not yet received successfully, and when a data entity is split into more than one data field,
transmitting and receiving each data field comprising a part of the data entity with a sub
field indicating which data fields comprising a part of the data entity the transmitting apparatus has not yet received successfully.

7. The method of claim 6, further comprising:
transmitting and receiving data fields comprising a part of the data entity wherein the data fields comprise information on how to combine the parts of the data entity together.

8. The method of claim 6, further comprising:
transmitting and receiving data fields comprising a part of the data entity wherein the data fields comprise information on the size of the part of the data entity in the data field.

9. The method of claim 6, further comprising:
continuing the transmission of data fields comprising a part of the data entity until receiving a data field with a subfield indicating that all data fields comprising a part of the data entity have been received successfully.

10. The method of any preceding claim 6, further comprising:
transmitting a data field comprising only a sub field indicating which data fields comprising a part of the data entity the transmitting apparatus has not yet received successfully if the receiving apparatus has indicated there are no data fields it has not received.

11. A computer program product encoding a computer program of instructions for executing a computer process carrying out the method of claim 6.
